(19) United States
(12) Patent Application Publication
(10) Pub. No.: US 2022/0267549 A1
(43) Pub. Date: Aug. 25, 2022

(54) RESIN COMPOSITION TO BE CROSS-LINKED AND FOAMED

(71) Applicant: MIZUNO CORPORATION, Osaka (JP)

(72) Inventor: Tetsuya Sasamori, Osaka (JP)

(21) Appl. No.: 17/571,713

(22) Filed: Jan. 10, 2022

(30) Foreign Application Priority Data
Feb. 25, 2021 (JP) 2021-028438

(51) Int. Cl. C08J 9/00; C08J 9/10; C08K 5/14; C08K 5/103; A43B 13/12; C08K 3/22; C08K 5/09; C08L 23/08

(52) U.S. Cl. CPC C08J 9/0061; C08J 9/10; C08K 5/14; C08K 5/103; C08J 9/0023; A43B 13/125; C08K 3/22; C08K 5/09; C08L 23/0853; C08J 2423/08; C08L 2207/04; C08L 2203/14; C08J 2201/026; C08J 2453/00; C08J 2323/08; C08J 2205/00; C08K 2003/2296; C08L 2203/30

(57) ABSTRACT

The resin composition to be cross-linked and foamed contains a thermoplastic resin, a cross-linking agent, and a foaming agent, and further contains a fatty acid and a fatty acid ester.

### CROSS-REFERENCE TO RELATED APPLICATION

This application claims priority to Japanese Patent Application No. 2021-028438 filed on Feb. 25, 2021, the entire disclosure of which is incorporated by reference herein.

### TECHNICAL FIELD

The present disclosure relates to a resin composition to be cross-linked and foamed into a cross-linked foam used for shoe soles.

### BACKGROUND

Shoes such as sports shoes include foams attached their intermediate portions (i.e., midsoles or insoles) to improve the comfort in walking or wearing the shoes and reduce fatigue, injury, or other problems.

Suggested as such a foam is, for example, a cross-linked foam for shoe soles made of a polymer containing an ethylene-vinyl acetate copolymer and/or polyethylene and an ethylene-butene copolymer as main components. Using such a polymer, a cross-linked foam is obtained which has a small weight, a high shock absorption, a high resilience, and a high tensile strength, according to descriptions (see, e.g., Japanese Unexamined Patent Publication No. H11-206406).

On the other hand, a cross-linked foam made of a polymer such as a styrene-based thermoplastic elastomer is suggested. The spin-spin relaxation time of the foam with the pulse nuclear magnetic resonance (NMR) (at 23° C.), and the complex modulus measured at a frequency of 1 Hz, a strain of 0.025%, and a rate of temperature rise of 2° C./min in dynamic viscoelasticity measurement satisfy predetermined conditions. According to the descriptions, such a configuration provides a cross-linked foam with a low specific gravity and a high heat resistance (see, e.g., Japanese Patent No. 5719980).

### SUMMARY

Expected to be used not only at ordinary temperature but also at high temperatures, sports or other types of shoes need to have heat resistances. The typical cross-linked foams described above however have the following problem. If the composition, blending ratios, and other conditions of a polymer are adjusted to increase the heat resistance, a resultant foam fails to have desired physical properties such as the expansion ratio and the rebound resilience.

The present disclosure was made in view of the problem. It is an objective to provide a resin composition to be cross-linked and foamed into a cross-linked foam having a higher heat resistance, while maintaining the same levels of expansion ratio and rebound resilience as the typical cross-linked foams.

In order to achieve the objective, the resin composition to be cross-linked and foamed according the present disclosure contains a thermoplastic resin, a cross-linking agent, and a foaming agent, and further contains a fatty acid and a fatty acid ester.

The present disclosure provides a resin composition to be cross-linked and foamed into a cross-linked foam having a higher heat resistance, while maintaining the same levels of expansion ratio and rebound resilience as the typical cross-linked foams.

### DETAILED DESCRIPTION

A preferred embodiment of the present disclosure will now be described.

A resin composition to be cross-linked and foamed according the present disclosure contains a thermoplastic resin, a fatty acid, a fatty acid ester, a cross-linking agent, and a foaming agent. The composition is to be cross-linked and foamed into a cross-linked foam for shoe soles.

<Thermoplastic Resin>

Examples of the thermoplastic resin according to the present disclosure include polyolefin-based elastomers (POE), olefin block copolymers (OBC), ethylene-vinyl acetate (EVA) copolymers, polyamides (PA), polyether block amides (PEBA), and styrene-based thermoplastic elastomers (TPS) (e.g., styrene-butadiene/butylene-styrene (SBBS) block copolymer). These may be used alone or in combination.

Among them, one or more selected from the group consisting of a polyolefin-based elastomer (POE), an olefin block copolymer (OBC), an ethylene-vinyl acetate (EVA) copolymer, and a polyether block amides (PEBA) may be used in one preferred embodiment in view of easily adjusting the strength and the rebound resilience of the resultant cross-linked foam to an appropriate range.

The content of the thermoplastic resin in the whole resin composition to be cross-linked and foamed preferably ranges from 50 mass % to 99 mass %, and more preferably ranges from 70 mass % to 97 mass %. The reasons follow. A content lower than 50 mass % means a higher content of the components other than the thermoplastic resin composition and may cause problems such as a higher viscosity and defective foaming. A content higher than 99 mass % may cause problems such as defective foaming due to shortage of the foaming agent.

<Fatty Acid>

The fatty acid used in the present disclosure may be stearic acid, lauric acid, or myristic acid, which may be used alone or in combination.

Using these fatty acids, the cross-linking agent decomposes into ions, which reduces excessive cross-linking reaction. Accordingly, the cross-linked foam formed from the resin composition according to the present disclosure has a higher heat resistance.

<Fatty Acid Ester>

The fatty acid ester used in the present disclosure may be a polyhydric alcohol fatty acid ester or a higher fatty acid ester, which may be used alone or in combination.

Examples of the polyhydric alcohol fatty acid ester include commercially available products such as Struktol WB222 manufactured by S & S Japan Co., LTD. Examples of the higher fatty acid ester include commercially available products such as Struktol WB212 manufactured by S & S Japan Co., LTD.

In use, the fatty acid ester chemisorbs on a peroxide, which reduces excessive cross-linking reaction. Accordingly, the cross-linked foam formed from the resin composition according to the present disclosure has a higher heat resistance.

In view of providing a cross-linked foam having a higher heal resistance, while maintaining the same levels of expansion ratio and rebound resilience as the typical cross-linked foams, the resin composition to be cross-linked and foamed according to the present disclosure contains, in addition to a thermoplastic resin, a cross-linking agent, and a foaming agent, the fatty acid and fatty acid ester described above in combination.

More specifically, the resin composition to be cross-linked and foamed exhibits a higher heat resistance using the fatty acid as described above. A higher content of the fatty acid however increases the change rate of the expansion ratio as in comparative examples which will be described later. The amounts of the cross-linking agent, the foaming agent, and other components need to be adjusted to satisfy a desired expansion ratio, which causes problems such as influences on mechanical properties such as the heat shrinkage and the tensile elongation.

Similarly, the resin composition to be cross-linked and foamed exhibits a higher heat resistance using the fatty acid ester as described above. A higher content of the fatty acid ester causes problems such as an extremely high change rate of the rebound resilience as in the comparative examples which will be described later.

Focusing on these points, the present inventors found that the following cross-linked foam is obtainable from a resin composition to be cross-linked and foamed containing a thermoplastic resin, a cross-linking agent and a foaming agent, using the above-described fatty acid and fatty acid ester with different mechanisms for reducing the cross-linking reaction in combination. The cross-linked foam has a higher heat resistance, while maintaining the same levels of expansion ratio and rebound resilience as the typical cross-linked foams.

In view of reliably obtaining a cross-linked foam with a higher heat resistance, while maintaining the same levels of expansion ratio and rebound resilience as the typical cross-linked foams, the sum of the contents of the fatty acid and the fatty acid ester ranges from 0.5 parts by mass to 4.0 parts by mass relative to 100 parts by mass of the thermoplastic resin in one preferred embodiment.

In use of the fatty acid and the fatty acid ester in combination, the contents of the fatty acid and the fatty acid ester range from 0.25 mass % to 1.0 mass % and 0.25 mass % to 3.0 mass %, respectively, with respect to 100 parts by mass of the thermoplastic resin.

<Cross-Linking Agent>

The cross-linking agent is not particularly limited and may be made of sulfur that is generally used as a cross-linking agent for a resin composition to be cross-linked and foamed, or an organic peroxide that promotes peroxide cross-linking. Examples of the organic peroxide include dicumyl peroxide, di-t-butyl peroxide, 2,5-dimethyl-2,5-di-(t-butylperoxy)hexane, 2,5-dimethyl-2,5-di-(t-butylperoxy)hexyne-3, 1,3-bis(t-butylperoxyisopropyl)benzene, 1,1-bis(t-butylperoxy)-3,3,5-trimethylcyclohexane, n-butyl-4,4-bis(t-butylperoxy)valerate, benzoyl peroxide, p-chlorobenzoyl peroxide, 2,4-dichlorobenzoyl peroxide, t-butyl peroxybenzoate, t-butyl perbenzoate, t-butyl peroxyisopropyl carbonate, diacetyl peroxide, lauroyl peroxide, and t-butyl cumyl peroxide. These may be used alone or in combination.

The content of the cross-linking agent with respect to the whole resin composition to be cross-linked and foamed ranges from 0.1 mass % to 3.0 mass %, and more preferably ranges from 0.3 mass % to 1.0 mass %. The reasons follow. A content lower than 0.1 mass % leads to inefficient cross-linking reaction, which may cause problems such defective foaming and a lower rebound resilience. A content higher than 3.0 mass % may excessively promotes cross-linking and cause thus inefficient foaming.

<Foaming Agent>

The foaming agent is not particularly limited, as long as generating a gas necessary for foaming the resin composition to be cross-linked and foamed, when being heated. Specific examples include N,N′-Dinitrosopentamethylenetetramine (DNPT), 4,4′-oxybis(benzenesulfonyl hydrazide) (OBSH), azodicarbonamide (ADCA), sodium hydrogen carbonate, sodium bicarbonate, ammonium bicarbonate, sodium carbonate, ammonium carbonate, azobis(isobutyronitrile), and barium azodicarboxylate. These may be used alone or in combination.

The content of the foaming agent in the whole resin composition to be cross-linked and foamed preferably ranges from 1.0 mass % to 15 mass %, and more preferably ranges from 1.5 mass % to 10 mass %. The reasons follow. A content lower than 1.0 mass % may cause problems such unstable foaming. A content higher than 15 mass % may cause problems such as various sizes of foam cells on the surface or inside the foam due to overfoaming.

With a cross-linking aid, a foaming aid, and other aids added, the resin composition according to the present disclosure is cross-linked and foamed under predetermined conditions, thereby obtaining a cross-linked foam.

<Cross-Linking Aid>

The crosslinking aid is not particularly limited. Examples include divinylbenzene, trimethylolpropane trimethacrylate, 1,6-hexanediol methacrylate, 1,9-nonanediol dimethacrylate, 1,10-decanediol methacrylate, trimellitic acid triallyl ester, triallyl isocyanurate, neopentyl glycol dimethacrylate, 1,2,4-benzenetricarboxylic acid triallyl ester, tricyclodecane dimethacrylate, and polyethylene glycol diacrylate. These may be used alone or in combination.

The content of the cross-linking aid in the whole resin composition to be cross-linked and foamed preferably ranges from 0.01 mass % to 5 mass %, and more preferably ranges from 0.1 mass % to 1 mass %. The reasons follow. A content lower than 0.01 mass % leads to inefficient progress of cross-linking, which may cause problems such as a lower rebound resilience. A content higher than 5 mass % may increase the specific gravity of the resin component and make it difficult to reduce the weight of resultant products.

<Foaming Aid>

The foaming aid is not particularly limited. Examples include urea compounds and zinc compounds such as zinc oxide. These may be used alone or in combination.

The content of the foaming aid in the whole resin composition to be cross-linked and foamed preferably ranges from 0.1 mass % to 10 mass %, and more preferably ranges from 0.5 mass % to 8.5 mass %. It is standard that the foaming aid and the foaming agent are added in the same amount. If the foaming aid is added in a smaller amount than the foaming agent, adjustment is needed as appropriate in accordance with the amount of the foaming agent, since some foaming agents may generate formaldehyde or other pollutants.

Next, a method of producing a cross-linked foam using the resin composition to be cross-linked and foamed according to the present disclosure will be described. The method of producing a cross-linked foam according to the present disclosure includes: kneading for preparing a resin composition to be cross-linked and foamed; and foaming and molding the foamed resin composition into a desired shape.

(Kneading)

First, raw materials such as a thermoplastic resin as a base material, a fatty acid, a fatty acid ester, a cross-linking agent, and a foaming agent are put into a kneading machine so as to be kneaded into a resin composition to be cross-linked and foamed.

The kneading machine for use may be a mixing roll, a calender roll, a Banbury mixer, or a kneader, for example.

Then, for example, a thermoplastic resin, a fatty acid, a fatty acid ester, a cross-linking aid, a cross-linking agent, a foaming aid, and a foaming agent are put in this order into a roll set at a predetermined temperature (e.g., a surface temperature of 100° C. to 120° C.) and kneaded, and then subjected to preforming such as sheeting or pelletizing.

Using a plurality of kneading machines, the kneading may be performed stepwise. For example, after a thermoplastic resin, a fatty acid, a fatty acid ester, and a foaming aid are put into a kneader and kneaded, the kneaded composition is moved to a roll, and a cross-linking agent and a foaming agent are put into the roll and kneaded and then subjected to preforming such as sheeting or pelletizing.

(Foaming and Molding)

Next, the resin composition obtained in the kneading fills a mold and is subjected to a heat treatment to promote foaming with the foaming agent, and then to a molding treatment and a release treatment, thereby preparing a resin composition to be cross-linked and foamed, in a desired shape.

While the heating temperature in the heat treatment depends on the types of the foaming agent and the foaming aid, the heat treatment is performed at a temperature (e.g., 120° C. to 180° C.) equal to or higher than the decomposition temperature of the foaming agent to be used. In addition, the heat treatment may be performed with the resin composition filling a mold and pressurized. The composition may be heated under ordinary pressure to promote the decomposition of the foaming agent.

As described above, the cross-linked foam according to the present disclosure can be produced.

In view of using the composition for shoes, the specific weight of the cross-linked foam according to the present disclosure is preferably 0.6 g/cm³ or less, and particularly preferably 0.4 g/cm³ or less, when used for shoe midsoles.

### EXAMPLES

The present disclosure will now be described based on examples. The present disclosure is not limited to these examples, and various modifications and variations of these examples can be made without departing from the scope and spirit of the present disclosure.

### Examples 1 to 15 and Comparative Examples 1 to 10

<Production of Cross-Linked Foam>

The cross-linked foams according to Examples 1 to 15 and Comparative Examples 1 to 10 with the compositions shown in Tables 1 and 2 (numbers indicate parts by mass of each component) were produced by the following production method.

(Kneading)

First, the thermoplastic resin, Foaming Aid 2 (i.e., zinc oxide), the fatty acid, the fatty acid ester, and the cross-linking aid shown in Tables 1 and 2 were put into a kneader set at 160° C. and kneaded for 8 to 12 minutes. Next, the kneaded composition was put into a 10-inch open roll (at a temperature of 100° C. to 120° C.). With the cross-linking agent, the first foaming aid, and the foaming agent shown in Tables 1 and 2 added, the raw materials were kneaded for 10 minutes into a resin composition to be cross-linked and foamed.

(Foaming and Molding)

First, 240 g of the produced resin composition was allowed to fill a mold (with a length of 175 mm, a width of 145 mm, and a height of 10 mm), and press molded under conditions of 165° C. and 20 MPa until being uniformly foamed until the inside, thereby obtaining a primary foam. Next, the primary foam was cut into pieces with a length of 200 mm, a width 124 mm, and a height of 16 mm, started being compressed at 165° C. so that the height of the pieces of the primary foam became 10 mm, and immediately started being cooled. While being compressed, the primary foam was cold-pressed until reaching ordinary temperature (e.g., 23° C.), thereby obtaining a secondary foam. This secondary foam was used as the cross-linked foams according to Examples 1 to 15 and Comparative Examples 1 to 10.

<Measurement of Specific Gravity>

The specific gravities of the produced cross-linked foams were measured under JIS K 7311 (i.e., collecting gas over water). More specifically, foam samples (with a length of 20 z 1 mm, a width of 15-1 mm, and a thickness of 10-1 mm) were prepared. Using an electronic hydrometer (MDS-300 manufactured by Alfa Mirage Co., Ltd.), the specific gravities [g/cm³] of the respective foam samples were calculated from the following formula (1) at a measurement temperature of 20±3° C. Tables 1 and 2 show the results.

[Math. 1]

D [g/cm³]=W₁/(W₁−W₂) (1)

in the formula, D represents the specific weight, W₁ represents the weight in air, and W₂ represents the weight in water.

<Measurement of Expansion Ratio>

A mold with a cavity whose inside is marked at a 100-mm interval was used. Defined as the expansion ratio was the percentage of the length after one day relative to the length (100 mm) immediately ater the molding.

In addition, the change rate [%] of the expansion ratio of each of Examples 1 to 14 and Comparative Examples 2 to 9 with respect to the expansion ratio of Comparative Example 1 (i.e., a cross-linked foam containing neither a fatty acid nor a fatty acid ester) as a reference was calculated from the following formula (2). With respect to Example 15, the change rate [%] with respect to the expansion ratio of Comparative Example 10 (i.e., a cross-linked foam containing neither a fatty acid nor a fatty acid ester) as a reference was calculated from the following formula (3). Tables 1 and 2 show the results.

In view of maintaining the expansion ratio, the absolute values of the change rates of 0.5% or less were marked with ∘, whereas the absolute values of the change rates higher than 0.5% were marked with X. Tables 1 and 2 show the results.

[Math. 2]

Change Rate [%] of Expansion Ratio=(((Expansion Ratio of Comparative Example 1)−(Expansion Ratio of each of Examples 1 to 14 or Comparative Examples 2 to 9))/(Expansion Ratio of Comparative Example 1))×100 (2)

[Math. 3]

Change Rate [%] of Expansion Ratio=(((Expansion Ratio of Comparative Example 10)−(Expansion Ratio of Example 15))/(Expansion Ratio of Comparative Example 10)×100 (3)

<Measurement of Rebound Resilience>

The rebound resiliences of the produced cross-linked foams were measured under ASTM-D2632. More specifically, foam samples (with a thickness of 10-1 mm) were prepared. Using Vertical Rebound Resilience Tester GT-7042-V manufactured by GOTECH TESTING MACHINES INC., a metal plunger was dropped on each foam sample seven times at a S-second interval under the condition of 23° C. In the last five times, the pointer positions [%] (i.e., the rebound heights) when the metal plunger stopped after rebound were read. The average of the read values was referred to as the rebound resilience [%]. In addition, the change rate [%] of the rebound resilience of each of Examples 1 to 14 and Comparative Examples 2 to 9 with respect to the rebound resilience of Comparative Example 1 (i.e., the cross-linked foam containing neither a fatty acid nor a fatty acid ester) as a reference was calculated from the following formula (4). With respect to Example 15, the change rate [%] of the rebound resilience of Comparative Example 10 (i.e., the cross-linked foam containing neither a fatty acid nor a fatty acid ester) as a reference was calculated from the following formula (5).

In view of maintaining the rebound resilience, the absolute values of the change rates of 5.4% or less were marked with ∘, whereas the absolute values of the change rates higher than 5.4% were marked with X. Tables 1 and 2 show the results.

[Math. 4]

Change Rate [%] of Rebound Resilience=(((Rebound Resilience of Comparative Example 1)−(Rebound Resilience of each of Examples 1 to 14 or Comparative Examples 2 to 9))/(Rebound Resilience of Comparative Example 1))×100 (4)

[Math. 5]

Change Rate [%] of Rebound Resilience=(((Rebound Resilience of Comparative Example 10)−(Expansion Ratio of Example 15))/(Rebound Resilience of Comparative Example 10))×100 (5)

<Measurement of Thermal Shrinkage>

First, each test piece was prepared in a size of 200 mm×124 mm×10 mm. A straight line was drawn in parallel to the long side of this test piece 10 mm inside the long side, and points were marked on the straight line at a 150-mm interval. Next, this test piece was left in a constant temperature bath at 70° C. for two hours and then in a constant temperature bath at 23′C for one hour. After that, how many millimeters the interval between the points marked on the test piece shrunk from the 150 mm (i.e., the amount of shrinkage) was measured. The percentage of the amount of shrinkage with respect to the initial interval was referred to as the thermal shrinkage [%].

In addition, the improvement rate [%] of the thermal shrinkage of each of Examples 1 to 14 and Comparative Examples 2 to 9 with respect to the heat shrinkage of Comparative Example 1 (i.e., the cross-linked foam containing neither a fatty acid nor a fatty acid ester) as a reference was calculated from the following formula (6). With respect to Example 15, the improvement rate [%] with respect to the thermal shrinkage of Comparative Example 10 (i.e., the cross-linked foam containing neither a fatty acid nor a fatty acid ester) as a reference was calculated from the following formula (7).

In Comparative Example 7 containing a fatty acid (at a content of 0.55 mass %) but no fatty acid ester, the improvement rate of the thermal shrinkage was 41%. In Examples 1 to 15 using the fatty acid and the fatty acid ester in combination, those with the improvement rates of the thermal shrinkages more than 41% were determined as the cross-linked foams with higher heat resistances. Improvement rates of 42% or more were marked with ∘, whereas improvement rates lower than 42% were marked with X. Tables 1 and 2 show the results.

[Math. 6]

Improvement Rate [%] of Thermal Shrinkage=(((Thermal Shrinkage of Comparative Example 1)−(Thermal Shrinkage of each of Examples 1 to 14 or Comparative Examples 2 to 9))/(Thermal Shrinkage of Comparative Example 1))×100 (6)

[Math. 7]

Improvement Rate [%] of Thermal Shrinkage=(((Thermal Shrinkage of Comparative Example 10)−(Thermal Shrinkage of Example 15)/(Thermal Shrinkage of Comparative Example 10))×100 (7)

TABLE 1

| | | E1 | E2 | E3 | E4 | E5 | E6 | E7 | E8 |
|---|---|---|---|---|---|---|---|---|---|
| Blending | Thermoplastic | 52.5 | 52.5 | 52.5 | 52.5 | 52.5 | 52.5 | 52.5 | 52.5 |
| Ratio (parts | Resin 1 | | | | | | | | |
| by mass) | Thermoplastic | 17.5 | 17.5 | 17.5 | 17.5 | 17.5 | 17.5 | 17.5 | 17.5 |
| | Resin 2 | | | | | | | | |
| | Thermoplastic | 25 | 25 | 25 | 25 | 25 | 25 | 25 | 25 |
| | Resin 3 | | | | | | | | |
| | Thermoplastic | 5 | 5 | 5 | 5 | 5 | 5 | 5 | 5 |
| | Resin 4 | | | | | | | | |
| | Fatty Acid 1 | 0.55 | 0.55 | 0.55 | 0.55 | 0.55 | 0.25 | 0.55 | 0.55 |
| | Fatty Acid 2 | 0 | 0 | 0 | 0 | 0 | 0 | 0 | 0 |
| | Fatty Acid 3 | 0 | 0 | 0 | 0 | 0 | 0 | 0 | 0 |
| | Fatty Acid Ester 1 | 0.25 | 0.5 | 0.75 | 1 | 3 | 0.25 | 0 | 0 |
| | Fatty Acid Ester 2 | 0 | 0 | 0 | 0 | 0 | 0 | 0.5 | 1 |
| | Cross-Linking Aid | 0.10 | 0.10 | 0.10 | 0.10 | 0.10 | 0.10 | 0.10 | 0.10 |
| | Cross-Linking | 0.68 | 0.68 | 0.68 | 0.68 | 0.68 | 0.68 | 0.68 | 0.68 |
| | Agent | | | | | | | | |
| | Foaming Agent | 2.8 | 2.8 | 2.8 | 2.8 | 2.8 | 2.8 | 2.8 | 2.8 |
| | Foaming Aid 1 | 2.8 | 2.8 | 2.8 | 2.8 | 2.8 | 2.8 | 2.8 | 2.8 |
| | Foaming Aid 2 | 0.96 | 0.96 | 0.96 | 0.96 | 0.96 | 0.96 | 0.96 | 0.96 |
| | Fatty Acid + Fatty | 0.80 | 1.05 | 1.30 | 1.55 | 3.55 | 0.50 | 1.05 | 1.55 |
| | Acid Ester | | | | | | | | |
| | Sum | 108.14 | 108.39 | 108.64 | 108.89 | 110.89 | 107.84 | 108.39 | 108.89 |
| Evaluation | Specific Gravity | 0.17 | 0.16 | 0.16 | 0.17 | 0.16 | 0.16 | 0.16 | 0.17 |
| | [g/cm³] | | | | | | | | |
| | Expansion Ratio | 1.94 | 1.91 | 1.91 | 1.87 | 1.95 | 1.94 | 1.94 | 1.89 |
| | (After Cooling) | | | | | | | | |
| | [%] | | | | | | | | |
| | Change Rate [%] | −3.2 | −1.6 | −1.6 | 0.5 | −3.7 | −3.2 | −3.2 | −0.5 |
| | of Expansion | | | | | | | | |
| | Ratio | | | | | | | | |
| | Rebound | 61 | 61 | 61 | 62 | 60 | 61 | 62 | 63 |
| | Resilience [%] | | | | | | | | |
| | Change Rate [%] | 3.2 | 3.2 | 3.2 | 1.6 | 4.8 | 3.2 | 1.6 | 0 |
| | of Rebound | | | | | | | | |
| | Resilience | | | | | | | | |
| | Thermal | 2.2 | 2.4 | 2.2 | 2.3 | 1.6 | 2.8 | 2.2 | 2.2 |
| | Shrinkage [%] | | | | | | | | |
| | Improvement | 54 | 51 | 55 | 52 | 67 | 42 | 53 | 54 |
| | Rate [%] of | | | | | | | | |
| | Thermal | | | | | | | | |
| | Shrinkage | | | | | | | | |
| | Change Rate [%] | ◯ | ◯ | ◯ | ◯ | ◯ | ◯ | ◯ | ◯ |
| | of Expansion | | | | | | | | |
| | Ratio | | | | | | | | |
| | ◯: ±5.0% or less | | | | | | | | |
| | Change Rate [%] | ◯ | ◯ | ◯ | ◯ | ◯ | ◯ | ◯ | ◯ |
| | of Rebound | | | | | | | | |
| | Resilience | | | | | | | | |
| | ◯: ±5.4% or less | | | | | | | | |
| | Improvement | ◯ | ◯ | ◯ | ◯ | ◯ | ◯ | ◯ | ◯ |
| | Rate [%] of | | | | | | | | |
| | Thermal | | | | | | | | |
| | Shrinkage | | | | | | | | |
| | ◯: 42% or more | | | | | | | | |
| | | | E9 | E10 | E11 | E12 | E13 | E14 | E15 |
| | Blending | Thermoplastic | 52.5 | 52.5 | 52.5 | 52.5 | 52.5 | 52.5 | 100 |
| | Ratio (parts | Resin 1 | | | | | | | |
| | by mass) | Thermoplastic | 17.3 | 17.5 | 17.5 | 17.5 | 17.5 | 17.5 | 0 |
| | | Resin 2 | | | | | | | |
| | | Thermoplastic | 25 | 25 | 25 | 25 | 25 | 25 | 0 |
| | | Resin 3 | | | | | | | |
| | | Thermoplastic | 5 | 5 | 5 | 5 | 5 | 5 | 0 |
| | | Resin 4 | | | | | | | |
| | | Fatty Acid 1 | 0 | 0 | 0.5 | 0.5 | 0.8 | 1 | 0.25 |
| | | Fatty Acid 2 | 0.55 | 0 | 0 | 0 | 0 | 0 | 0 |
| | | Fatty Acid 3 | 0 | 0.55 | 0 | 0 | 0 | 0 | 0 |
| | | Fatty Acid Ester 1 | 0.5 | 0.5 | 2.5 | 2 | 0.5 | 0.5 | 0.25 |
| | | Fatty Acid Ester 2 | 0 | 0 | 0 | 0 | 0 | 0 | 0 |
| | | Cross-Linking Aid | 0.10 | 0.10 | 0.10 | 0.10 | 0.10 | 0.10 | 0.10 |
| | | Cross-Linking | 0.68 | 0.68 | 0.68 | 0.68 | 0.68 | 0.68 | 0.65 |
| | | Agent | | | | | | | |
| | | Foaming Agent | 2.8 | 2.8 | 2.8 | 2.8 | 2.8 | 2.8 | 2.8 |
| | | Foaming Aid 1 | 2.8 | 2.8 | 2.8 | 2.8 | 2.8 | 2.8 | 2.8 |
| | | Foaming Aid 2 | 0.96 | 0.96 | 0.96 | 0.96 | 0.96 | 0.96 | 1 |
| | | Fatty Acid + Fatty | 1.05 | 1.05 | 3.00 | 2.50 | 1.30 | 1.50 | 0.50 |
| | | Acid Ester | | | | | | | |
| | | Sum | 108.39 | 108.39 | 110.34 | 109.84 | 108.64 | 108.84 | 107.85 |
| | Evaluation | Specific Gravity | 0.17 | 0.16 | 0.17 | 0.17 | 0.17 | 0.17 | 0.17 |
| | | [g/cm³] | | | | | | | |
| | | Expansion Ratio | 1.96 | 1.96 | 1.95 | 1.96 | 1.95 | 1.93 | 1.91 |
| | | (After Cooling) | | | | | | | |
| | | [%] | | | | | | | |
| | | Change Rate [%] | −4.3 | −4.3 | −3.7 | −4.3 | −3.7 | −2.7 | −3.8 |
| | | of Expansion | | | | | | | |
| | | Ratio | | | | | | | |
| | | Rebound | 63 | 62 | 61 | 60 | 61 | 62 | 67 |
| | | Resilience [%] | | | | | | | |
| | | Change Rate [%] | 0 | 1.6 | 3.2 | 4.8 | 3.2 | 1.6 | −1.5 |
| | | of Rebound | | | | | | | |
| | | Resilience | | | | | | | |
| | | Thermal | 2.3 | 2.4 | 1.7 | 1.43 | 2.22 | 1.45 | 3.2 |
| | | Shrinkage [%] | | | | | | | |
| | | Improvement | 52 | 50 | 65 | 70 | 54 | 70 | 60 |
| | | Rate [%] of | | | | | | | |
| | | Thermal | | | | | | | |
| | | Shrinkage | | | | | | | |
| | | Change Rate [%] | ◯ | ◯ | ◯ | ◯ | ◯ | ◯ | ◯ |
| | | of Expansion | | | | | | | |
| | | Ratio | | | | | | | |
| | | ◯: ±5.0% or less | | | | | | | |
| | | Change Rate [%] | ◯ | ◯ | ◯ | ◯ | ◯ | ◯ | ◯ |
| | | of Rebound | | | | | | | |
| | | Resilience | | | | | | | |
| | | ◯: ±5.4% or less | | | | | | | |
| | | Improvement | ◯ | ◯ | ◯ | ◯ | ◯ | ◯ | ◯ |
| | | Rate [%] of | | | | | | | |
| | | Thermal | | | | | | | |
| | | Shrinkage | | | | | | | |
| | | ◯: 42% or more | | | | | | | |

E: Example

TABLE 2

| | | CE1 | CE2 | CE3 | CE4 | CE5 | CE6 | CE7 | CE8 | CE9 | CE10 |
|---|---|---|---|---|---|---|---|---|---|---|---|
| Blending | Thermoplastic | 52.5 | 52.5 | 52.5 | 52.5 | 52.5 | 52.5 | 52.5 | 52.5 | 52.5 | 100 |
| Ratio (parts | Resin 1 | | | | | | | | | | |
| by mass) | Thermoplastic | 17.5 | 17.5 | 17.5 | 17.5 | 17.5 | 17.5 | 17.5 | 17.5 | 17.5 | 0 |
| | Resin 2 | | | | | | | | | | |
| | Thermoplastic | 25 | 25 | 25 | 25 | 25 | 25 | 25 | 25 | 25 | 0 |
| | Resin 3 | | | | | | | | | | |
| | Thermoplastic | 5 | 5 | 5 | 5 | 5 | 5 | 5 | 5 | 5 | 0 |
| | Resin 4 | | | | | | | | | | |
| | Fatty Acid 1 | 0 | 0 | 0 | 0 | 0 | 0.1 | 0.5.5 | 1 | 3 | 0 |
| | Fatty Acid 2 | 0 | 0 | 0 | 0 | 0 | 0 | 0 | 0 | 0 | 0 |
| | Fatty Acid 3 | 0 | 0 | 0 | 0 | 0 | 0 | 0 | 0 | 0 | 0 |
| | Fatty Acid Ester 1 | 0 | 0.1 | 0.5 | 1.0 | 3.0 | 0 | 0 | 0 | 0 | 0 |
| | Fatty Acid Ester 2 | 0 | 0 | 0 | 0 | 0 | 0 | 0 | 0 | 0 | 0 |
| | Cross-Linking Aid | 0.10 | 0.10 | 0.10 | 0.10 | 0.10 | 0.10 | 0.10 | 0.10 | 0.10 | 0.10 |
| | Cross-Linking | 0.68 | 0.68 | 0.68 | 0.68 | 0.68 | 0.68 | 0.68 | 0.158 | 0.68 | 0.65 |
| | Agent | | | | | | | | | | |
| | Foaming Agent | 2.8 | 2.8 | 2.8 | 2.8 | 2.8 | 2.8 | 2.8 | 2.8 | 2.8 | 2.8 |
| | Foaming Aid 1 | 2.8 | 2.8 | 2.8 | 2.8 | 2.8 | 2.8 | 2.8 | 2.8 | 2.8 | 2.8 |
| | Foaming Aid 2 | 0.96 | 0.96 | 0.96 | 0.96 | 0.96 | 0.96 | 0.96 | 0.96 | 0.96 | 1 |
| | Fatty Acid + Fatty | 0.00 | 0.10 | 0.50 | 1.00 | 3.00 | 0.10 | 0.55 | 1.00 | 3.00 | 0 |
| | Acid Ester | | | | | | | | | | |
| | Sum | 107.34 | 107.44 | 107.84 | 108.34 | 110.34 | 107.44 | 107.89 | 108.34 | 110.34 | 107.35 |
| Evaluation | Specific Gravity | 0.17 | 0.17 | 0.17 | 0.17 | 0.17 | 0.17 | 0.16 | 0.17 | 0.16 | 0.19 |
| | [g/cm³] | | | | | | | | | | |
| | Expansion Ratio | 1.88 | 1.90 | 1.92 | 1.93 | 1.95 | 1.88 | 1.93 | 1.99 | 2.01 | 1.84 |
| | (After Cooling) | | | | | | | | | | |
| | [%] | | | | | | | | | | |
| | Change Rate [%] | — | −1.1 | −2.1 | −2.7 | −3.7 | 0 | −2.7 | −5.9 | −6.9 | — |
| | of Expansion | | | | | | | | | | |
| | Ratio | | | | | | | | | | |
| | Rebound | 63 | 63 | 64 | 62 | 59 | 63 | 61 | 63 | 60 | 66 |
| | Resilience [%] | | | | | | | | | | |
| | Change Rate [%] | — | 0 | -1.6 | 1.6 | 6.3 | 0 | 3.2 | 0 | 4.8 | — |
| | of Rebound | | | | | | | | | | |
| | Resilience | | | | | | | | | | |
| | Thermal | 4.8 | 4.2 | 4.2 | 3.0 | 2.4 | 3.0 | 2.8 | 2.5 | 0.1 | 8.1 |
| | Shrinkage [%] | | | | | | | | | | |
| | Improvement | — | 12 | 13 | 38 | 50 | 37 | 41 | 48 | 97 | — |
| | Rate [%] of | | | | | | | | | | |
| | Thermal | | | | | | | | | | |
| | Shrinkage | | | | | | | | | | |
| | Change Rate [%] | — | ◯ | ◯ | ◯ | ◯ | ◯ | ◯ | X | X | — |
| | of Expansion | | | | | | | | | | |
| | Ratio | | | | | | | | | | |
| | ◯: ±5.0% or less | | | | | | | | | | |
| | Change Rate [%] | — | ◯ | ◯ | ◯ | X | ◯ | ◯ | ◯ | ◯ | — |
| | of Rebound | | | | | | | | | | |
| | Resilience | | | | | | | | | | |
| | ◯: ±5.4% or less | | | | | | | | | | |
| | Improvement | — | X | X | X | ◯ | X | X | ◯ | ◯ | — |
| | Rate [%] of | | | | | | | | | | |
| | Thermal | | | | | | | | | | |
| | Shrinkage | | | | | | | | | | |
| | ◯: 42% or more | | | | | | | | | | |

CE: Comparative Example

The materials used to produce the cross-linked foams are as follows.

(1) Thermoplastic Resin 1: TAFMER DF-810 (an α-olefin copolymer with an MFR (at 190° C.) of 1.2 g/10 min, a density of 0.885 g/cm³, and a melting point of 66° C. manufactured by Mitsui Chemicals, Inc.)

(2) Thermoplastic Resin 2: INFUSE 9530 (an α-olefin block copolymer with an MFR (at 190° C.) of 5.0 g/10 min, a density of 0.887 g/cm³, and a melting point of 119° C. manufactured by Dow Chemical Company)

(3) Thermoplastic Resin 3: EVATHENE (Registered Trademark) UE659 (an ethylene-vinyl acetate copolymer with an MFR (at 190° C.) of 2.0 g/10 min, a density of0.947 g/cm³, a melting point of 77° C., and a VA amount of 25%).

(4) Thermoplastic Resin 4: PEBAX 3533 SPO1 (a polyether block amide with an MFR (235° C. and with 1 kg) of 8 g/10 min, a density of 1.00 g/cm³, and a melting point of 144° C. manufactured by Arkema)

(5) Thermoplastic Resin 5: TUFTEC P1083P (a styrene-butadiene/butylene-styrene partially hydrogenated block copolymer with an MFR (at 190° C.) of 3.0 g/10 min and a density of 0.89 g/cm³ manufactured by Asahi Kasei Corporation)

(6) Fatty Acid 1: Stearic Acid Camellia (stearic acid manufactured by NOF CORPORATION)

(7) Fatty Acid 2: NA-142 (lauric acid manufactured by NOF CORPORATION)

(8) Fatty Acid 3: NA-122 (myristic acid manufactured by NOF CORPORATION)

(9) Fatty Acid Ester 1: Struktol-WB222 (a polyhydric alcohol fatty acid ester manufactured by S & S Japan Co., LTD.)

(10) Fatty Acid Ester 2: Struktol-WB212 (a higher fatty acid ester manufactured by S & S Japan Co., LTD.)

(11) Cross-linking Aid: TAC/GR70 (triallyl isocyanurate manufactured by Kcttlitz-Chemic GmbH & Co. KG)

(12) Cross-Linking Agent; Percumyl D (dicumyl peroxide manufactured by NOF CORPORATION)

(13) Foaming Agent: Cellular D (N,N′-Dinitrosopentamethylenetetramine manufactured by EIWA CHEMICAL IND. CO., LTD.)

(14) Foaming Aid 1: Cellpaste 101 (urea manufactured by ElWA CHEMICAL IND. CO., LTD.)

(15) Foaming Aid 2: Active Zinc Oxide (AZO) (zinc oxide manufactured by SEIDO CHEMICAL INDUSTRY CO., LTD.)

It is found from Table 1 that the resin compositions to be cross-linked and foamed in Examples 1 to 14 contain the fatty acid and the fatty acid ester and that the resultant cross-linked foams exhibit thus higher heat resistances, while maintaining the same levels of expansion ratio and rebound resilience as the resin composition to be cross-linked and foamed in Comparative Example 1 containing neither a fatty acid nor a fatty acid ester.

It is also found that Example 15 contains, as the thermoplastic resin, only Thermoplastic Resin 1 and that, as with Examples 1 to 14, the resultant cross-linked foam exhibits a higher heat resistance, while maintaining the same level of expansion ratio and rebound resilience as the resin composition to be cross-linked and foamed in Comparative Example 10 containing neither a fatty acid nor a fatty acid ester.

On the other hand, it is found that Comparative Examples 2 to 4 contain lower contents (less than 3 parts by mass with respect to 100 parts by mass of the thermoplastic resin) of a fatty acid ester but no fatty acid, and exhibit lower improvement rates of the heat shrinkages.

It is found that Comparative Example 3 contains a higher content (3 parts by mass or more with respect to 100 parts by mass of the thermoplastic resin) of a fatty acid ester but no fatty acid, and exhibits a lower rebound resilience.

On the other hand, it is found that Comparative Examples 6 and 7 contain lower contents (less than 1 parts by mass with respect to 100 parts by mass of the thermoplastic resin) of a fatty acid but no fatty acid ester, and exhibit lower improvement rates of the heat shrinkages.

It is found that Comparative Examples 8 and 9 contain higher contents (1 parts by mass or more with respect to 100 parts by mass of the thermoplastic resin) of a fatty acid but no fatty acid ester, and exhibits higher change rates of the expansion ratios.

As described above, the present disclosure is particularly useful as a resin composition to be cross-linked and foamed into a cross-linked foam used for shoe soles.

What is claimed is:

1. A resin composition to be cross-linked and foamed, the resin composition comprising: a thermoplastic resin; a cross-linking agent; and a foaming agent; the resin composition further comprising:
a fatty acid; and a fatty acid ester.

2. The resin composition of claim 1, wherein
the thermoplastic resin is at least one selected from the group consisting of a polyolefin-based elastomer (POE), an olefin block copolymer (OBC), an ethylene-vinyl acetate (EVA) copolymer, a polyamide (PA), a polyether block amide (PEBA), and a styrene-based thermoplastic elastomer (TPS).

3. The resin composition of claim 1, wherein
a sum of a content of the fatty acid and a content of the fatty acid ester ranges from 0.5 parts by mass to 4.0 parts by mass relative to 100 parts by mass of the thermoplastic resin.

4. The resin composition of claim 3, wherein
the content of the fatty acid ranges from 0.25 mass % to 1.0 mass %.

5. The resin composition of claim 3, wherein
the content of the fatty acid ester ranges from 0.25 mass % to 3.0 mass %.

6. The resin composition of claim 1, wherein
the fatty acid is at least one selected from the group consisting of stearic acid, lauric acid, and myristic acid.

7. The resin composition of claim 1, wherein
the fatty acid ester is at least one of a polyhydric alcohol fatty acid ester or a higher fatty acid ester.

8. A cross-linked foam formed from the resin composition of claim 1.

9. The cross-linked foam of claim 8 with a specific gravity of 0.6 g/cm³ or less.

10. The cross-linked foam of claim 8 for a midsole of a shoe.
